(19) United States
(12) Patent Application Publication
(10) Pub. No.: US 2012/0131456 A1
(43) Pub. Date: May 24, 2012

(54) Capture and Playback for GUI-Based Tasks

(75) Inventors: Qingwei Lin, Beijing (CN); Fan Li, Beijing (CN); Jiang Li, Beijing (CN)

(73) Assignee: Microsoft Corporation, Redmond, WA (US)

(21) Appl. No.: 12/952,010

(22) Filed: Nov. 22, 2010

(51) Int. Cl. G06F 3/01

(52) U.S. Cl. 715/704

(57) ABSTRACT

Described herein are techniques for capture and playback of user-performed GUI-based (Graphical User Interface) tasks across multiple GUI-based applications. The described techniques include performing the playback of such tasks without depending upon the playback environmental conditions matching the original capture conditions.

### BACKGROUND

Some surveys have suggested that employees may spend as much as an hour of a typical workday performing repetitive operations on a computer. Of course, a computer can be, and often is, programmed to repetitively perform a particular set of operations. Unfortunately, many users are not sufficiently technically savvy enough to program a computer to perform a set of operations repeatedly. Even if a user has the technical savvy to script a set of tasks, many of those savvy users do not take the time to write an appropriate script to perform the set of tasks.

Moreover, few, if any, conventional options exist for scripting a set of operations over multiple applications available on one of the many available GUI-based (Graphical User Interface) Operating System (OS) environments. Present solutions offer application-specific “macro” scripting capabilities within particular applications. For example, an application-specific macro can be run within a word-processing application. However, as the label suggests, application-specific macros do not operate across multiple applications in a GUI-based OS environment.

There are many conventional options available to record and later replay keyboard and mouse input on a computer system. Such conventional options capture keyboard and mouse events at an OS level to record the user's operations. Later, the recorded keyboard and mouse events are simply replayed when the captured user operations are reenacted.

Unfortunately, in order to accurately reproduce the results of the user operations, the conventional keyboard/mouse event capture option requires that a replay environment exactly match the original environment. Since environmental conditions (such as window position, window size, target element, etc.) may vary between the original recording environment and the later replay environment, the mere replay of the captured events might not produce the desired outcome. For example, if a window position or size of a GUI-based application differs slightly, a replay of mouse events might miss the target element (e.g., a button or input box) because the target element is positioned differently between the original recording environment and the replay environment.

Accordingly, no existing solution exists that offers a record and replay approach for GUI-based tasks without being either dependent upon a specific application or upon a match between the original recording environmental conditions and the replay environmental conditions.

### SUMMARY

Described herein are techniques for capture and playback of user-performed GUI-based (Graphical User Interface) tasks across multiple GUI-based applications. The described techniques include performing the playback of such tasks without depending upon the playback environmental conditions matching the original capture conditions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is a pictorial diagram of an example computing environment that implements techniques to facilitate capture and playback of user-performed GUI-based (Graphical User Interface) tasks as described herein.

FIG. 2 is a block diagram of a module configured to implement the techniques described herein to facilitate capture and playback of user-performed GUI-based tasks.

FIG. 3 is a block diagram that shows interactions of some aspects of one or more implementations of the techniques described herein to facilitate capture and playback of user-performed GUI-based tasks.

FIGS. 4 and 5 are flow diagrams of one or more example processes, each of which implements the techniques described herein.

### DETAILED DESCRIPTION

Described herein are techniques for capture and playback of user-performed GUI-based (Graphical User Interface) tasks across multiple GUI-based applications. The described techniques include performing the playback of such tasks without depending upon the playback environmental conditions matching the original capture conditions. Example aspects that make up the environmental conditions include window position, window size, active or hidden by other windows, and position of elements (e.g. button, link, menu, input box, toolbar, lists, etc.) inside the window.

With the techniques described herein, the GUI-elements of GUI-based tasks are captured. When later triggered, the captured element-based records are accurately played back so that a target element of each record is located quickly (regardless of the particular GUI-application that owns the element) and acted upon in accordance with the manner as captured.

The following co-owned U.S. patent application is incorporated herein by reference and made part of this application: U.S. Ser. No. 12/948,353, filed on Nov. 17, 2010, titled “Automatic Batching of GUI-based Tasks,” and having common inventorship.

### Example Computing Environment

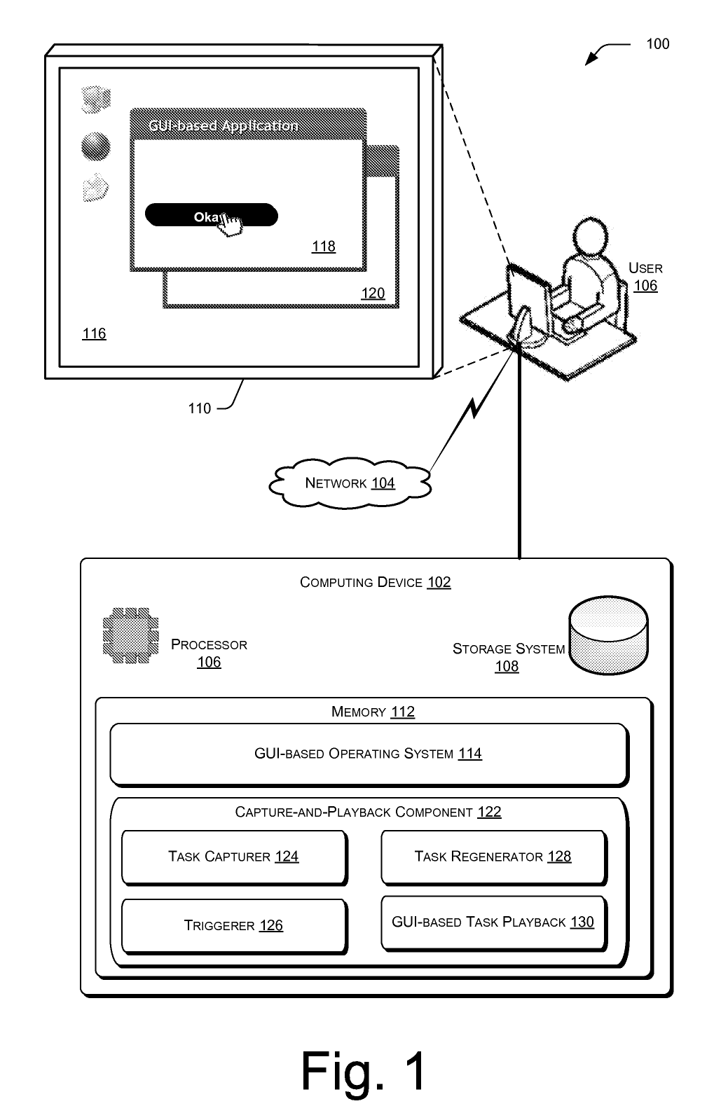

FIG. 1 illustrates an example computing environment 100 that may implement the described techniques for capture and playback of GUI-based tasks. The environment 100 may include at least one computing device 102, which may be coupled together via a network 104 to form a distributed system with other devices. A user 106 may operate the computer device 102 to conduct work, to search for information, to write an email, to edit a video, to create a business presentation, or other such actions. Although not necessarily illustrated, the computing device 102 has input/output subsystems, such as a keyboard, mouse, speakers, etc. The network 104, meanwhile, represents any one or combination of multiple different types of networks interconnected with each other and possibly functioning as a single large network (e.g., the Internet or an intranet). The network 104 may include wire-based networks (e.g., cable) and wireless networks (e.g., cellular, satellite, etc.).

The computing device 102 of this example computer environment 100 includes one or more processors 106, one or more storage systems 108, at least one monitor 110, and one or more memories 112. Running, at least in part, on the computing device 102 is an Operating System (OS) 114 and, in particular, this OS interacts with the user 106 via a Graphical User Interface (GUI). Herein, this OS is called the GUI-based OS 114. An example of a typical GUI-based user interface (UI) 116 of a GUI-based OS 114 is shown on the monitor 110. This example UI 116 includes two example GUI-based applications 118 and 120 that might be displayed on such a UI.

FIG. 1 shows a component 122 for the capture and playback of GUI-based tasks, which is called the capture-and-playback component 122 herein. This component is shown as residing in the memory 112 as a module of computer-executable instructions. However, of course, in alternative embodiments, the capture-and-playback component 122 may be implemented in hardware, firmware, or some combination of hardware, software, or firmware. The capture-and-playback component 122 may be implemented as part of the GUI-based OS 114 or running under, or in cooperation with, the OS.

As depicted, the capture-and-playback component 122 includes at least four modules: a task capturer 124, a triggerer 126, a task regenerator 128, and a GUI-based task playback 130. Each of these modules is described generally below. In the following section about the capture-and-playback component 122, more details of these modules are discussed. With different implementations, the functionality of these modules may be organized differently (e.g., in different modules, with more or fewer modules, etc.) and, indeed, may be independent of each other and not part of the same component, such as the capture-and-playback component 122.

When the user 106 wishes to record, for later playback, a series of GUI-based tasks, she activates the task capturer 124, which may be done by clicking on an on-screen icon or button. Then, the user 106 performs a series of GUI-based tasks within the context of the GUI-based environment of the GUI-based OS 114. While the user performs these tasks, the task capturer 124 tracks them and records them. Those tracked tasks may be performed over multiple GUI-based applications. The tasks are recorded in a defined format that is used for the later playback. In the same or similar manner, the user 106 may indicate that task capturing is completed. The task capturer 124 may store the captured set of tasks in the memory 112 and/or the storage system 108.

The tracked and recorded tasks may include for example, clicking on a button, double-clicking on an icon, selecting an item in a list, entering values in an input box, right-clicking, and the like. The series of captured tasks may include tasks performed with multiple different GUI-based applications, such as applications 118 and 120. Indeed, the task capturer 124 is particularly suited to capture the user's actions across multiple GUI-based applications.

Using the triggerer 126, the user 106 may replay the set of captured tasks whenever she desires. Furthermore, the user may define conditions under which a specified set of captured tasks are triggered automatically. When such conditions occur, the triggerer 126 automatically initiates the playback of the specified set of captured tasks. Alternatively, the user 106 may manually replay the captured tasks via the triggerer 126.

Once triggered, the task regenerator 128 regenerates the set of captured tasks and the GUI-based task playback 130 plays back the regenerated set of captured tasks. The task regenerator 128 obtains the stored record of a specified series of tasks. For each recorded task, the task regenerator 128 determines the location of the target GUI-based element, regardless of differences between environmental conditions when the task was captured and the present conditions when the task is being played back. The task regenerator 128 produces similar inputs/events to mimic the user performing the captured operation.

With the cooperation of the task regenerator 128, the GUI-based task playback 130 plays back the regenerated set of captured tasks. In some implementations, the GUI-based task playback 130 may visually simulate the user performing the regenerated task. Ultimately, the GUI-based task playback 130 performs the specified series of tasks.

### Example Capture-and-Playback Component

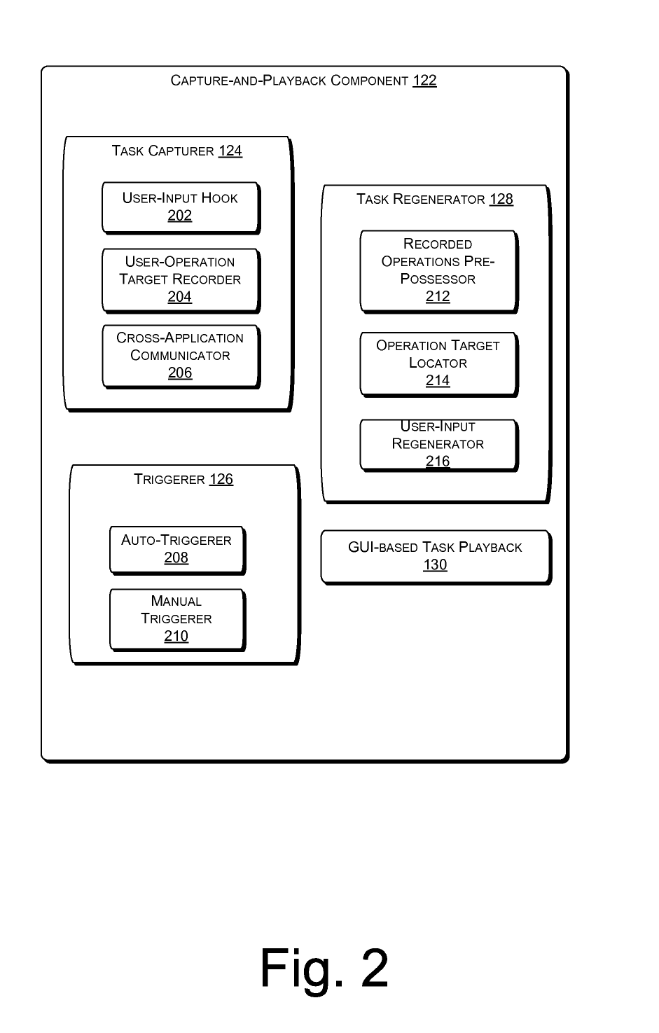

FIG. 2 illustrates more details of at least one embodiment of the capture-and-playback component 122, which was introduced and briefly described in the context of FIG. 1. As noted, the capture-and-playback component 122 includes at least four modules: the task capturer 124, the triggerer 126, the task regenerator 128, and the GUI-based task playback 130.

The task capturer 124 tracks and records the user 106 performing a series of GUI-based tasks within the context of GUI-based environment of the GUI-based OS 114. Those tracked tasks may be performed over multiple GUI-based applications. The task capturer 124 includes at least three sub-modules: a user-input hook 202, a user-operation target recorder 204, and a cross-application communicator 206.

Once the user activates capture of tasks, the task capturer 124 observes and records the actions performed by the user as she goes about performing various tasks via inputs, such as those from the keyboard and a mouse. Regardless of which application (e.g., GUI-based applications 118 and 120) is being used by the user, the task capturer 124 captures the user-performed GUI-based tasks. Indeed, the task capturer 124 may track the user's actions across multiple GUI-based applications, such as GUI-based applications 118 and 120. Tracked tasks may include inputs from the keyboard or mouse or from a touchscreen for selections of options of a GUI-based application.

The user-input hook 202 gets information about user input from applications that accept such input. The user-input hooks 202 are typically OS-wide and enable capturing of user tasks across multiple applications. Rather than an application-specific function, a user-input hook 202 provides the link for capturing the keyboard/mouse events to implement the described techniques for capture and playback of GUI-based tasks. Some implementations may use high-level hooks, some may use low-level hooks, and others may use both.

The user-input hook 202 may be implemented via application programming interfaces (APIs) and/or dynamic link library (DLLs) or other similar approaches. As a system-wide DLL, the user-input hook 202 is loaded by user-interfacing applications as it is launched with cooperation of the GUI-based OS 114. In this way, the user-input hook 202 is automatically attached to active applications so that user input is captured via those applications. Examples of such APIs are part of the UI automation/accessibility frameworks, such as Microsoft Active Accessibility (MSAA) and its successor, the Microsoft UI Automation (UIA), which are supported by various GUI-based operating systems by the Microsoft Corporation. Such frameworks are a general interface for most GUI-based applications, and can get the information of basic GUI-based elements, such as the button, link, menu, input box, file, window, etc.

Using user-input information provided by the user-input hook 202, the user-operation target recorder 204 identifies the GUI element (e.g., the button, link, menu, input box, file, window, etc.) that is the subject of the user's GUI-based actions. This GUI element is called the user-operation target or more simply the operation target. The user-operation target recorder 204 identifies the detail information of the GUI element, such as the element type, element name, and its parent component's information.

The user-operation target recorder 204 determines the operation types (e.g., the mouse/keyboard events) and operation element (e.g., which button/menu in which window is clicked) of each captured task. For example, if the user operation involves a mouse click (e.g., a left-click, double-click, or right-click), the user-operation target recorder 204 may use the mouse position to retrieve information on the operation target. If, for example, the user operation involves a mouse move, the user-operation target recorder 204 records the mouse positions for the move. If the example operation is a keyboard entry, then the user-operation target recorder 204 may monitor the input from the keyboard (e.g., the “e” key, the “k” key, etc.).

The following are examples of the information retrieved by the user-operation target recorder 204 (the list is provided for illustration only and not limitation):
Process name: the process name of the target, which is typically the highest-level information.
Main window: the information of the main window, such as the window name and type.
Frame windows: the inheritors of the main window. The window relations form a tree structure, from the main window to the last level of frame window.
Element: typically, the smallest granularity in the operation target, which will specify the operation target in the lowest level. For example, an “OK” button, or an input box.
Element path: the internal UI (User Interface) path from the last frame window to the element. The path may be recorded in a tree structure. The objects in the element path may not be visible in the UI, but they can be used to uniquely locate the element.
Absolute position: the position of the operation.
Frame window rectangle: the position and size of the last-level frame window. This value can be used to restore the window in a playback stage.
Status and value: the status and value of the element, for example, whether it is focusable or not, and the value in the element.
Time stamp: the time point of the operation.

For example, consider that the subject operation involved selecting the “Bold” button in a word processor application. In this example the following information may be captured:
Process name: “WPPROG.EXE”
Main window: “Word Processor”
Frame window: “WordProcessor”, “WpoCommandBarDock”, “WpoCommandBar”, “WpoWorkPane”, “NUIPane”, “NetUIHWND”
Element path: “window”:“Ribbon”, “property page”:“Ribbon”, “pane”:“Lower Ribbon”, “client”:“”, “property page”:“Home”, “tool bar”:“Font”
Element: “push button”:“Bold”
Absolute position: 162 91
Frame window rectangle: (0 0 1280 992)
State and value: “normal” “”
Time stamp: 50421722 (ms)

With the information about the user operation provided by the user-input hook 202, the user-operation target recorder 204 creates a unique identification of each user operation in a defined format. Each operation record, as a record of each user operation is called, is stored as a combination of the operation type and the operation element. The structure of the operation record enables a unique representation of the operation target and an operation type so as to indicate the user interaction. Implementations may use new or existing structures of the operation records. A suitable existing structure includes those offered by MSAA or UIA.

The operation-record structure contains the information of the process name, main window info, and frame window info, together with a hierarchy tree structure of the element. For example, the element of an “OK” button in the “Save as . . . ” dialog of a specific application called “X”, may have the information of process name “WinX”, main window of “X”, frame window to be the “Save as . . . ” dialog, and a hierarchy tree structure from the frame window to the “OK” button. With this data structure, the target element may be accessed later when tasks are played back.

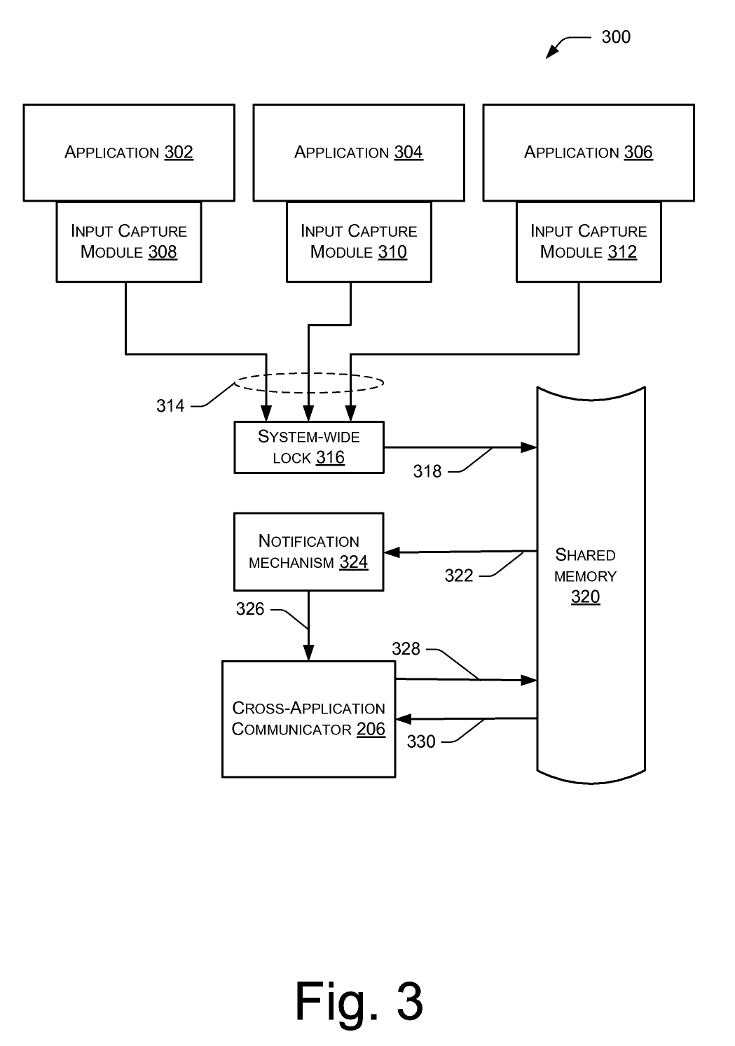

Via the user-input hook 202, the task capturer 124 may receive information from multiple co-running applications. In order to retrieve the user operations, the cross-application communicator 206 acts as a central command center to collect the multiple capture operations and store them together. As part of the discussion of FIG. 3 below, the cross-application communicator 206 is described in more detail.

Some events (such as a defined user input or a time-out) indicate to the task capturer 124 that it should end recording of a set of tasks. The task capturer 124 may give the set a default name or a user-provided label. The named set of tasks may be stored together in the memory 112 or the storage system 108 of the computer device 102

Using the triggerer 126, the user may define circumstances that will trigger the invocation of the just-recorded, or some other existing set of, captured tasks. Of course, alternatively, the user may manually trigger the invocation of an already recorded set of tasks. The triggerer 126 includes at least two sub-modules: an auto-triggerer 208 and a manual triggerer 210.

If the user chooses to have a specified set of captured tasks automatically invoked by the triggerer 126, the task sets may be scheduled to occur based upon defined timing and/or triggered upon the occurrence of enumerated events. The auto-triggerer 208 may prompt the user 106 to provide triggering conditions upon the completion of the capturing of the set of tasks. Alternatively, the user may later set the triggering conditions of any specific set of recorded tasks.

If time is the triggering condition, then the auto-triggerer 208 decides to trigger the task-set playback when the scheduled time condition occurs. Using the auto-triggerer 208, the user may be allowed to set a time condition for triggering. That is, the user may set a schedule to trigger specified sets of captured tasks. Examples of such time conditions include (but are not limited to) only once per designated time (e.g., hour, day, week, month, etc.), specified times and/or days, and the like.

If events are the triggering condition, then the auto-triggerer 208 triggers a task-set playback once it decides that one or more designated event conditions have occurred. In this context, an example of an “event” is where the OS sends a notification to the capture-and-playback component 122 when the defined event occurs. The following are examples of events that may be used to trigger a playback (provided as illustration only and not limitation):
File events, including the events for file created, file deleted, file modified, and file renamed.
Directory events, including directory created, directory deleted, and directory renamed.
File events in directory, including any file changes in a directory.
System logon/logoff events, including system logon, logoff, start, shutdown, and restart.
Service events, which indicate any status change in the service, including service started, stopped, restarted, and paused.
Application events, which means any status change in the application running, including application started, stopped, and crashed.
User customized events: The user can manually set a system event for monitoring, and if the event is captured by the system, the playback will be triggered.

Using the auto-triggerer 208, the user 106 may select one or more of the above event conditions (and perhaps others not listed) as being a trigger to start the playback function of a specified set of captured tasks. Of course, alternatively, the user may manually trigger the invocation of an already recorded set of tasks. This may be accomplished, for example, by the user clicking on an icon, a system-tray icon, a customized icon for a specified set of tasks, or other such user-initiated triggering.

Once triggered, the task regenerator 128 regenerates the specified set of captured tasks. The GUI-based task playback 130 works in cooperation with the task regenerator 128 to play back the specified set of captured tasks. The task regenerator 128 includes at least three sub-modules: a recorded operations pre-processor 212, an operation target locator 214 and a user-input regenerator 216.

The task regenerator 128 obtains the stored record of a specified series of tasks. The recorded operations (“rec-ops”) pre-processor 212 translates the captured low-level user input into high-level user operations. For example, left mouse down and left mouse up within a short time interval may be translated into a left click operation. In addition, for example, a keyboard virtual scan code may be translated into a meaningful character input. Also, the rec-ops pre-processor 212 may cull out redundant and meaningless operations.

After the translation and culling, the rec-ops pre-processor 212 structures the translated user operations into a pre-defined format, such as the already-discussed operation-record structure. In that format, each line may represent a user operation. In at least one implementation, each user operation includes at least two parts: the operation target and the operation type. The operation target indicates what element the user performed their operation upon (e.g., a button, an input box, etc.) and the operation type indicates what kind of operation was performed (e.g., a left click, a drag, etc.).

After the formatting, the GUI-based task playback 130 loads the translated and formatted operations, initiates a thread to read each operation (typically, one-by-one), and completes the playback. While doing this, and with or before each operation is played back, the GUI-based task playback 130 cooperates with the operation target locator 214 and the user-input regenerator 216 to regenerate the user input so that the operation is mimicked (i.e., simulated).

For each formatted and translated operation, the operation target locator 214 determines the location of the target GUI-based element regardless of differences between environmental conditions when the task was captured and the present conditions when the task is being played back. The operation target locator 214 locates and verifies the correct target before the user-input regenerator 216 regenerates the input. Because of this, the capture-and-record component 122 is adaptive to differences in environment conditions (between when the tasks were recorded and when the tasks are later replayed).

The operation target locator 214 quickly locates a target element by using a pre-defined tree structure to represent the unique path of the target element when it was recorded by the task capturer 124. When recorded, the tree structure of the frame windows is captured to replace a major part of the element tree. This approach reduces the element searching time significantly.

The operation target locator 214 restores the target window to have the same size and position as during the recording stage. In doing this, the target element will typically be at the same position in the playback stage as it was in the recording stage. The operation target locator 214 directly verifies whether the target element exists at the same position. If it exists at the same position, then the operation target locator 214 has located the target element.

When locating a target element, the operation target locator 214 uses the captured target information, which includes the process name, main window, frame windows, element path, element, absolute position, frame window rectangle, status and value, and the time stamp.

To restore the environmental conditions to those of the recording stage of a particular recorded operation, the operation target locator 214 looks for the correct running process and the main window. Next, the operation target locator 214 looks for the frame windows. The frame windows are recorded as a tree structure. The operation target locator 214 follows the tree structure to get the last level of a frame window. The operation target locator 214 restores the frame window conditions to be the same as they were during the recording stage. This restoration includes setting the target window to foreground, moving the window to the target position, and resizing the window. The operation target locator 214 verifies the target element is located at the same position as it was during the recording stage. If the same element is located at the same location as it was during the recording stage, the operation target locator 214 has located its target for this particular operation record. Otherwise, the operation target locator 214 locates the target element with the hybrid tree structure of the window/element path. If the target element is still not found, the operation target locator 214 replays the mouse movements between the previous operation and the current one and looks for the target element while doing so. Replaying the mouse movements may be useful because sometimes the target element only appears when the mouse hovers over, or when the mouse moves with a specified path.

Once the operation target is located, the user-input regenerator 216 regenerates the keyboard/mouse input to mimic (i.e., simulate) the user operations as though the user was controlling the input. That is, the user-input regenerator 216 produces similar inputs/events to mimic the user performing the captured operation. Consequently, the task regenerator 128 visually simulates the user performing the regenerated task. Ultimately, the GUI-based task playback 130 performs the specified series of tasks.

The capture-and-playback component 122 sends keyboard/mouse events to the OS 114 to regenerate the user input. The following table includes examples of keyboard/mouse events that may be sent (provided for illustration and not limitation):

TABLE 1
keyboard/mouse events regeneration

| User operation | Regenerated Keyboard/mouse events |
|---|---|
| Mouse Move | Mouse move event from current position to target |
| | position |
| Left Click | Mouse move to target position, left mouse down, |
| | left mouse up |
| Right Click | Mouse move to target position, right mouse down, |
| | right mouse up |
| Double Click | Mouse move to target position, left mouse down, |
| | left mouse up, left mouse down, left mouse up |
| Drag | Mouse move to first position, left mouse down, |
| | mouse move to second position, left mouse up |
| Keyboard inputs | If input value can be retrieved from the input |
| | element, directly set the value into the target |
| | element |
| | If input value fails to be retrieved, send keyboard |
| | events onto the target element |

### Example Cross-Application Communicator

FIG. 3 illustrates an example operational context 300 of at least one embodiment of the cross-application communicator 206, which was introduced and briefly described in the context of FIG. 2. The operational context 300 includes three example GUI-based applications, which are application 302, application 304, and application 306. These applications represents applications that interface (i.e., interact) with the user 106 via input mechanisms like a keyboard or a mouse. GUI-based applications 118 and 120 of FIG. 1 may be representations of the same type of applications as those of 302-306. As shown in FIG. 3, the applications 302-306 represent the programs, modules, routines, etc., as they reside in memory, such as memory 112 for FIG. 1.

As depicted in FIG. 3, each application has an input capture module attached thereto. Input capture module 308 is attached to application 302, input capture module 310 is attached to application 304, and input capture module 312 is attached to application 306. Each of these modules may be embodiments of, part of, or work in cooperation with the user-input hook 202 described above. The user-input hook 202 gets information about user input from applications, such as 302-306 that accept such input. The input capture modules 308-312 are the modules that actually obtain the information directly from such applications. In some instances, each of the input capture modules 308-312 may be implemented as DLLs that dynamically attach to each of the multiple applications as each executes.

As each of the input capture modules 308-312 obtains user-input information from its respective application, it sends the obtained information, via data-ready-for-writing lines 314, to a system-wide lock 316. Of course, the data-ready-for-writing lines 314 represent one or more communication paths and are not necessarily a dedicated hardwired link. The system-wide lock 316 (e.g. “mutex”) writes the received information, via the data-writing link 318, to a shared memory 320. The shared memory 320 may be part of the memory 112 shown in FIG. 1 or it may be a separate memory. The shared memory 320 is called that because it is shared by multiple applications (e.g., applications 302-306) via their input capture modules.

Since confusion and conflict might result from unfettered access to the shared memory 320, the system-wide lock 316 limits or controls access to the shared memory 320. The system-wide lock 316 controls where and how the collected information is written to the shared memory 320.

When the writing of captured user operation data is complete (as indicated via a signal from a writing-complete line 322), the notification mechanism 324 (e.g. “semaphore”) notifies the cross-application communicator 206. Once it gets the notification signal (via 326), the cross-application communicator 206 requests the written data (via line 328) from the shared memory 320. The cross-application communicator 206 receives the stored captured user-input information via a reading-data line 330.

### Example Processes

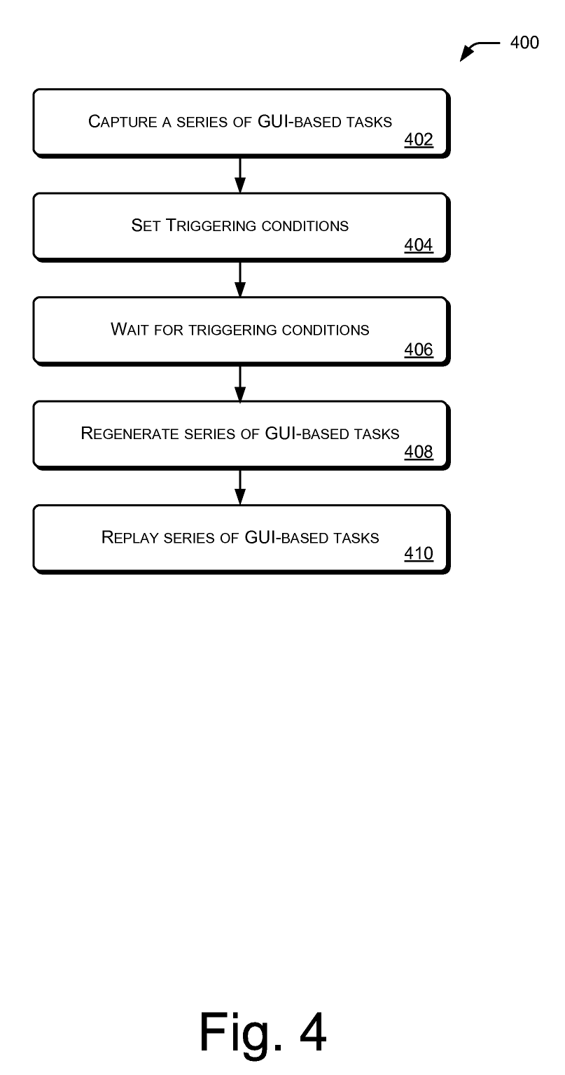

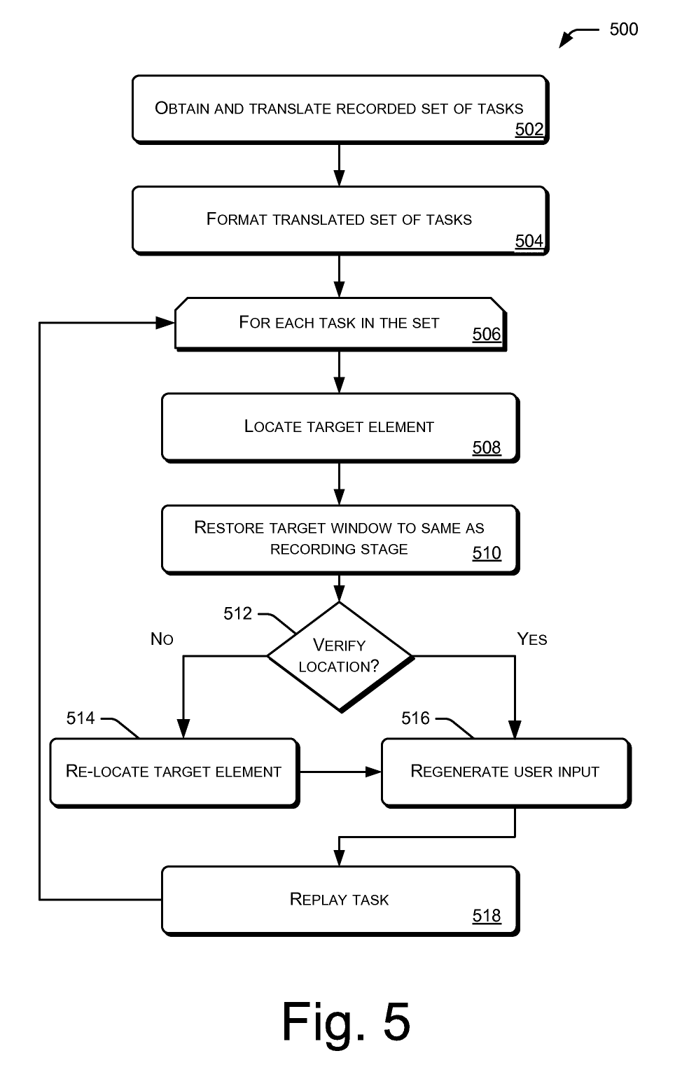

FIGS. 4 and 5 are flow diagrams illustrating example processes 400 and 500 that implement the techniques described herein for capture and playback of GUI-based tasks. These processes are illustrated as a collection of blocks in a logical flow graph, which represents a sequence of operations that can be implemented in hardware, software, firmware, or a combination thereof. In the context of software, the blocks represent computer instructions stored on one or more computer-readable storage media that, when executed by one or more processors of such a computer, perform the recited operations. Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

FIG. 4 illustrates the example process 400 for the capture and playback of GUI-based tasks. The process 400 is performed, at least in part, by a computing device or system, which includes, for example, the computing system 102 of FIG. 1. The computing device or system is configured to facilitate the capture and playback of GUI-based tasks. The computing device or system so configured qualifies as a particular machine or apparatus.

As shown here, the process 400 begins with operation 402, where the computing device captures a series of GUI-based tasks. Those tasks may be performed over multiple GUI-based applications. When the user 106 wishes to record for later playback a series of GUI-based tasks, she initiates operation 402, which may be done by clicking on an on-screen icon or button. Then, the user 106 performs a series of GUI-based tasks within the context of a GUI-based environment of the GUI-based OS 114. While the user performs these tasks, the computing device tracks them and records them. The tasks are recorded in a defined format that eases the later playback. In the same or similar manner, the user 106 may indicate that task capturing is completed. As part of operation 402, the computing device may store the set of just captured tasks in the memory 112 and/or the storage system 108.

At operation 404, the computing device offers the user 106 an opportunity to set the conditions under which a specified set of captured tasks are triggered automatically. Such conditions may, for example, be time-based or event-based. When such conditions occur, the computing device initiates the playback of the specified set of captured tasks.

At operation 406, the computing device waits for the triggering conditions and once those occurs it triggers the playback of recorded GUI-based tasks. The triggering may be automated or performed manually. Alternatively, the user 106 may manually replay the captured tasks.

Once triggered, at operation 408, the computing device regenerates the GUI-based tasks based upon the recorded tasks. The computing device obtains the stored record of a specified series of tasks. For each recorded task, the computing device determines the location of the target GUI-based element regardless of differences between environmental conditions when the task was captured and the present conditions when the task is being played back. The computing device produces similar inputs/events to mimic the user performing the captured task.

At operation 410, the computing device replays the regenerated GUI-based tasks. As part of the playback, the computing device may visually simulate the user performing the regenerated task. More details about operations 408 and 410 (regeneration and replay of GUI-based tasks) are provided in process 500 of FIG. 5.

FIG. 5 illustrates the example process 500 for the capture and playback of GUI-based tasks. The process 500 is performed, at least in part, by a computing device or system, which includes, for example, the computing system 102 of FIG. 1. The computing device or system is configured to facilitate capture and playback of GUI-based tasks. The computing device or system so configured qualifies as a particular machine or apparatus.

As shown here, the process 500 begins with operation 502, where the computing device obtains the stored record of a specified series of tasks. The computing device translates the captured low-level user input into high-level user operations. For example, left mouse down and left mouse up within a short time interval may be translated into a left click operation. In addition, for example, a keyboard virtual scan code may be translated into a meaningful character input. In addition, the computing device culls out redundant and meaningless operations. Examples of such operations include those that do not direct or initiate the performance of an action by an application or by the OS.

At operation 504, the computing device structures the remaining translated user operations into a pre-defined format, such as the already-discussed operation-record structure. In at least one implementation, each user operation includes at least two parts: the operation target and the operation type. The operation target indicates what element the user performed their operation upon (e.g., a button, an input box, etc.) and the operation type indicates what kind of operation was performed (e.g., a left click, a drag, etc.).

At operation 506, the computing device loads the translated and formatted operations and initiates a loop to read and replay each operation (typically, one operation at a time) of the specified series of tasks. Operations 506-518 are performed in a loop so that the computing device performs each operation for each task in the series.

At operation 508, the computing device locates a target element by using the pre-defined tree structure to represent the unique path of the target element when it was recorded. When recorded, the tree structure of the frame windows is captured to replace a major part of the element tree.

When locating a target element, the computing device uses the captured target information, which includes the process name, main window, frame windows, element path, element, absolute position, frame window rectangle, status and value, and the time stamp.

At operation 510, the computing device restores the target window to have the same size and position as during the recording stage. In doing this, the target element will typically be at the same position in the playback stage as it was in the recording stage.

To restore the environmental conditions to those of the recording stage of a particular recorded operation, the computing device looks for the correct running process and the main window. Next, the computing device looks for the frame windows. The frame windows are recorded as a tree structure. The computing device follows the tree structure to get the last level of the frame windows. The computing device restores the frame window conditions to be the same as it was during the recording stage. This restoration includes setting the target window to foreground, moving the window to the target position, and resizing the window.

At operation 512, the computing device verifies that the restored element is located at the same position as it was during the recording stage. If the same element is located at the same location as it was during the recording stage, the computing device has completed its target location for this particular operation record.

If not verified, the computing device, at operation 514, attempts to find the target element with the hybrid tree structure of window/element path. If the target element is still not found, the computing device replays the mouse movements between the previous operation and the current one and looks for the target element while doing so.

At operation 516, the computing device regenerates the keyboard/mouse input in order to mimic (i.e., simulate) the user operations as though the user was controlling the input. That is, the computing device produces similar inputs/events to mimic the user performing the captured task. Consequently, the computing device visually simulates the user performing the regenerated task.

At operation 518, the computing device replays the specified set of tasks using the regenerated keyboard/mouse input. In so doing, the computing device simulates performing the captured task.

### CONCLUDING NOTES

As used in this application, the terms “component,” “module,” “system,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of example, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof, to control a computer to implement the disclosed subject matter. The term computer-readable media includes computer-storage media and communication media. For example, computer-storage media may include, but are not limited to, magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize that many modifications may be made to this configuration without departing from the scope or spirit of the claimed subject matter.

As used in this application, the term “or” is intended to mean an inclusive “or” rather than an exclusive “or”. That is, unless specified otherwise or clear from context, “X employs A or B” is intended to mean any of the natural inclusive permutations. That is, if X employs A, X employs B, or X employs both A and B, then “X employs A or B” is satisfied under any of the foregoing instances. In addition, the articles “a” and “an” as used in this application and the appended claims should generally be construed to mean “one or more”, unless specified otherwise or clear from context to be directed to a singular form.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

We claim:

1. A method that facilitates capture and playback of Graphical User Interface (GUI) based tasks in a GUI-based environment, the method comprising:
capturing a series of GUI-based tasks input by a user within a context of the GUI-based environment;
setting conditions which will trigger a replay of the captured series of GUI-based tasks;
determining whether triggering conditions have occurred;
in response to the determining:
triggering the replay of the captured series of GUI-based tasks;
locating GUI-based targets of the captured series of GUI-based tasks;
based upon the located targets, regenerating user input for the replay of the captured series of GUI-based tasks;
based upon the regenerated user input, replaying the captured series of GUI-based tasks, wherein the replaying includes visually simulating a user providing user input in performing the captured series of GUI-based tasks.

2. A method as recited in claim 1 further comprising storing the captured series of GUI-based tasks using a defined format for storing GUI-based tasks.

3. A method as recited in claim 1, wherein the captured series of GUI-based tasks includes tasks performed within a context of multiple GUI-based applications.

4. A method as recited in claim 1, wherein the capturing includes collecting information about user input from multiple GUI-based applications.

5. A method as recited in claim 1, wherein the triggering, locating, regenerating, and replaying occur in response to a determination that triggering conditions have occurred.

6. A method as recited in claim 1, wherein the triggering, locating, regenerating, and replaying occur in response to the user manually initiating the performance of the triggering, locating, regenerating, and replaying.

7. A method as recited in claim 1, wherein the triggering conditions include time-based or event-based conditions.

8. A method as recited in claim 1, wherein the locating comprises, for a particular task of the captured series of GUI-based tasks, restoring environmental conditions of the particular task during the replaying of the particular task to the environmental conditions that existed when the particular task was captured.

9. A method as recited in claim 8, wherein the environmental conditions are selected from a group consisting of a process name, a main window, a frame window, an element path, an element, an absolute position, a frame window rectangle, a status and value, and a time stamp.

10. One or more computer-readable media storing processor-executable instructions that, when executed, cause one or more processors to perform operations that facilitate capture and playback of Graphical User Interface (GUI) based tasks in a GUI-based environment, the operations comprising:
capturing a series of GUI-based tasks received from a user within a context of the GUI-based environment, wherein a set of environmental conditions exists that describes the context of the GUI-based environment during the capturing;
replaying the captured series of GUI-based tasks, wherein another set of environmental conditions exists that describes a context of the GUI-based environment at the initiation of the replaying and the environmental conditions of the sets are unmatching.

11. One or more computer-readable media as recited in claim 10, wherein the capturing includes collecting information about user input from multiple GUI-based applications.

12. One or more computer-readable media as recited in claim 10, wherein the operations further comprise:
setting conditions which will trigger a replay of the captured series of GUI-based tasks;
determining whether triggering conditions have occurred;
in response to the determining, triggering the replaying.

13. One or more computer-readable media as recited in claim 10, wherein the replaying includes visually simulating a user providing user input in performing the captured series of GUI-based tasks.

14. One or more computer-readable media as recited in claim 10, wherein the environmental conditions are selected from a group consisting of a process name, a main window, a frame window, an element path, an element, an absolute position, a frame window rectangle, a status and value, and a time stamp.

15. One or more computer-readable media as recited in claim 10, wherein the replaying operation includes:
locating GUI-based targets of the captured series of GUI-based tasks;
based upon the located targets, regenerating user input for the replay of the captured series of GUI-based tasks;
based upon the regenerated user input, replaying the captured series of GUI-based tasks.

16. One or more computer-readable media as recited in claim 10, wherein the environmental conditions that describes a context of the GUI-based environment are selected from a list consisting of window position, window size, target element.

17. One or more computer-readable media storing processor-executable instructions that, when executed, cause one or more processors to perform operations that facilitate capture and playback of Graphical User Interface (GUI) based tasks in a GUI-based environment, the operations comprising:
triggering a playback of a captured series of GUI-based tasks input by a user within a context of the GUI-based environment;
in response to the triggering, playing back the captured series of GUI-based tasks, wherein the playing back includes a replay of tasks captured through multiple GUI-based applications.

18. One or more computer-readable media as recited in claim 17, wherein the playing back operation includes visually simulating a user providing user input in performing the captured series of GUI-based tasks.

19. One or more computer-readable media as recited in claim 17, wherein the playing back operation comprises:
locating GUI-based targets of the captured series of GUI-based tasks;
based upon the located targets, regenerating user input for the replay of the captured series of GUI-based tasks.

20. One or more computer-readable media as recited in claim 17, wherein the playing-back operation comprises:
obtaining the captured series of GUI-based tasks from a memory;
formatting each of the tasks of the obtained series of GUI-based tasks to specify a GUI-based operation target of each task;
locating GUI-based operation targets of each of the tasks of the captured series of GUI-based tasks;
based upon the located GUI-based operation targets, regenerating user input for the replay of the captured series of GUI-based tasks;
simulating a user providing user input in the playing back of each task of the captured series of GUI-based tasks.
